(19) United States
(12) Patent Application Publication
(10) Pub. No.: US 2025/0118894 A1
(43) Pub. Date: Apr. 10, 2025

(54) ANTENNA HOLDING DEVICE

(71) Applicant: Se Jin JUN, Gimhae-si (KR)

(72) Inventor: Se Jin JUN, Gimhae-si (KR)

(21) Appl. No.: 18/836,665

(22) PCT Filed: Sep. 23, 2022
(86) PCT No.: PCT/KR2022/014256

§ 371 Date: Aug. 7, 2024

(30) Foreign Application Priority Data
Feb. 8, 2022 (KR) 10-2022-0016147

(51) Int. Cl. H01Q 3/04; H01Q 1/12

(52) U.S. Cl. CPC H01Q 3/04; H01Q 1/1228

(57) ABSTRACT

An antenna holding device includes an upper body clamp coupled to a pillar or the like to fix an antenna, a lower body clamp disposed below the upper body clamp and coupled to the pillar or the like, an upper antenna bracket coupled to an upper portion of a rear surface of the antenna, a lower antenna bracket coupled at a lower side of the upper antenna bracket, a lower support bracket of which one side is connected to the lower body clamp and the other side is connected to the lower antenna bracket, wherein at least any one side is coupled using a hinge, and an angle adjusting member of which one side is hinge-coupled to the upper body clamp and the other side is hinge-coupled to the upper antenna bracket.

### TECHNICAL FIELD

The present invention relates to an antenna holding device, and more specifically, to an antenna holding device capable of allowing a radio wave orientation inclination angle of an antenna for a base station to be adjusted and maintaining the radio wave orientation inclination angle.

### BACKGROUND ART

In general, antennas are conversion devices for transmitting or receiving electromagnetic waves through a space and are essential devices for wirelessly transmitting and receiving information. As the demand for mobile communication has recently explosively increased, it is easy to see various types of mobile communication antennas installed on base stations and relays to achieve the purpose of communication. These mobile communication antennas need to be installed and maintained in directions in which an optimal transmission and reception ratio can be obtained for efficient transmission and reception of radio waves.

In this regard, in Korean Registered Patent Publication No. 10-0862143 (Sep. 30, 2008), a fixing apparatus with an adjustment function has been proposed. As illustrated in FIG. 1, a fixing device 26 including a body clamp 22 coupled to a pillar 14 such that an antenna 16 is fixed to the pillar 14, slide brackets 40 which are disposed on a rear surface of the antenna 16 corresponding to a frequency radiation plane in a width direction and provided to be spaced apart from each other in a vertical direction, and guide slots 44 which are formed in the slide brackets 40 such that a fixing bracket 32 connected to the body clamp 22 is movably coupled to the guide slot 44 and the antenna 16 moves horizontally with respect to the pillar 14 to be adjusted in a left-right direction is provided.

In the proposed technology, since the fixing bracket 32 is provided to be hinged by a plurality of link members, an installation direction of the antenna 16 may be vertically adjusted, and the installation direction of the antenna 16 may be adjusted in a left-right direction by horizontally moving the antenna 16 using the guide slot 44. Accordingly, the installation of the antenna can be adjusted.

However, in this case, since the adjustment of the installation direction of the antenna 16 using the guide slots 44 cannot significantly deviate from a width of the antenna 16 and it is impossible to adjust the installation direction in a rotational direction around the pillar 14, there is a problem of small displacement, and a force which maintains an installation state of the antenna 16 of which the installation direction is adjusted may be a frictional force between the slide bracket 40 and the fixing bracket 32 coupled through the guide slot 44, in general, there is a limit on overcoming a high wind speed using the above frictional force on a roof of a building or on top of a mountain where a base station for mobile communication is typically installed. In addition, coupling of the body clamp 22 and the fixing bracket 32 and coupling between the link members constituting the slide bracket 40 are performed by hinge-coupling (34) using bolts and nuts, which also has a problem that there is a limit on overcoming the high wind speed.

Meanwhile, recently, there has been a shift from 4^{th} generation mobile communications (4G networks) to 5^{th} generation mobile communications (5G networks) with a maximum speed of 20 Gbps, and unlike 4G, which uses frequencies of GHz or lower, 5G transmits data at high speeds using a wide bandwidth of hundreds of MHz or more in the high frequency bands of centimeter waves (3 GHz to 30 GHZ) and millimeter waves (30 GHz to 300 GHz).

However, when millimeter wave (mmWAVE) frequency bands of 24 GHz or higher are used in 5G, properties of a signal are similar to those of light, the signal may not avoid obstacles such as mountains or building, wavelength lengths range only from 1 to 10 mm, which narrows coverage in which base stations can transmit and receive frequencies, and there is a problem that much energy is consumed in signal transmission and reception when signals with high frequency bands are not transmitted in one direction. In addition, an existing 4G mobile communication antenna is a separate antenna separated from a transmitting and receiving device and weighs 9 to 16 kg, and since an antenna for 5G mobile communication is an integrated antenna combined with a transmitter and receiver and weighs 20 to 25 kg, when the antenna for 5G mobile communication is installed on one pole greater than 3 meters or a monopole of 2 meters or less among installation poles already installed on a rooftop or railing of a building, the antenna for 5G mobile communication should be installed at a height of 2 meters or less for safety reasons due to the weight. Accordingly, in the antenna for 5G mobile communication antenna, setting and maintaining an installation direction is more important than the antenna for the existing 4G in consideration of efficient transmission and reception of frequency signals and safety.

### Technical Problem

The present invention is directed to solving the above-described problems and providing an antenna holding device which allows an inclination angle of an antenna to be easily and freely adjusted and firmly maintains a set inclination angle.

### Technical Solution

In accordance with one aspect of the present invention, there is provided an antenna holding device including an upper body clamp coupled to a pillar or the like to fix an antenna, a lower body clamp disposed below the upper body clamp and coupled to the pillar or the like, an upper antenna bracket coupled to an upper portion of a rear surface of the antenna, a lower antenna bracket coupled at a lower side of the upper antenna bracket, a lower support bracket of which one side is connected to the lower body clamp and the other side is connected to the lower antenna bracket, wherein at least any one side is coupled using a hinge, and an angle adjusting member of which one side is hinge-coupled to the upper body clamp and the other side is hinge-coupled to the upper antenna bracket, wherein the angle adjusting member includes a first fixing link of which one side is hinge-coupled to the upper body clamp and a second fixing link of which one side is hinge-coupled to the upper antenna bracket, which are provided as a pair, and a first adjusting link of which one side is hinge-coupled to the first fixing link and a second adjusting link of which one side is hinge-coupled to the second fixing link, which are provided as a pair, the first fixing link and the second fixing link are hinge-coupled to each other, and the first adjusting link and the second adjusting link are hinge-coupled to each other.

In accordance with another aspect of the present invention, the antenna holding device may further include an angle adjustment rod which passes through and is coupled to a hinge-coupling portion between the first fixing link and the second fixing link and a hinge-coupling portion between the first adjusting link and the second adjusting link, wherein a screw thread may be formed on an outer circumferential surface of the angle adjustment rod such that an angle of the angle adjusting member is adjusted through rotation or counter-rotation of the angle adjustment rod.

In accordance with another aspect of the present invention, a rotary nut may be provided on one end of the angle adjustment rod.

In accordance with another aspect of the present invention, a protractor may be attached to one side surface of the lower support bracket.

### Advantageous Effects

An antenna holding device according to the present invention can allow an orientation angle of an antenna to be easily adjusted and firmly and stably maintain the adjusted inclination angle.

### DESCRIPTION OF DRAWINGS

FIG. 1 is a view illustrating a fixing device according to the conventional technology.

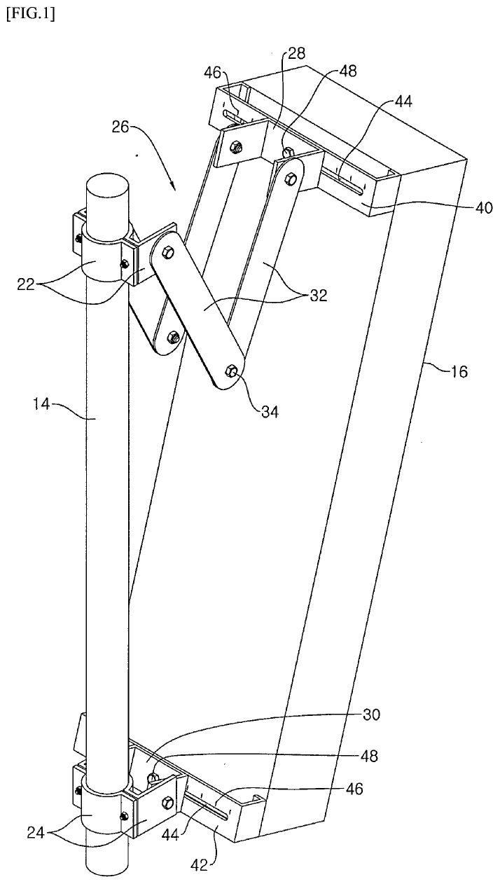

FIG. 2 is a perspective view illustrating an antenna holding device according to one embodiment of the present invention.

FIG. 3 is an enlarged view illustrating portion A of FIG. 2.

FIG. 4 is an enlarged view illustrating portion B of FIG. 2.

FIG. 5 is a view illustrating operations of the antenna holding device according to one embodiment of the present invention.

### MODES OF THE INVENTION

The above-described aspects and additional aspects will be clear through embodiments described below. In this specification, the same number is assigned to a corresponding component in each drawing. In addition, a shape or size of a component may be exaggerated compared to an actual component. In addition, a specific description of the related art will be omitted when deemed to unnecessarily obscure the gist of the present invention.

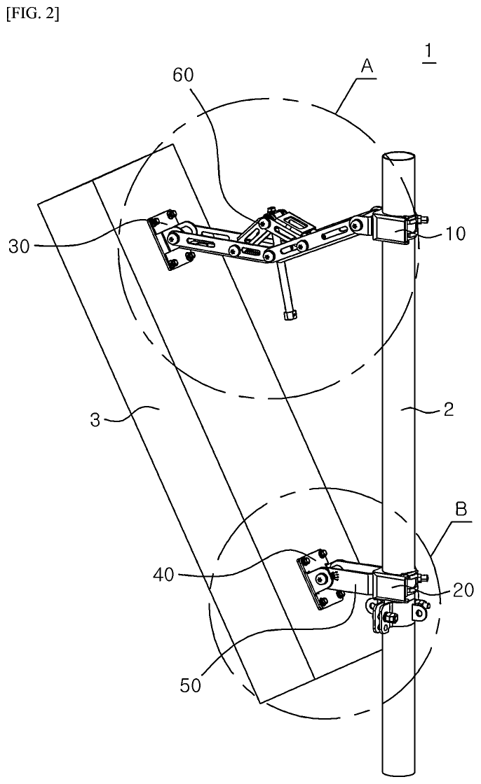

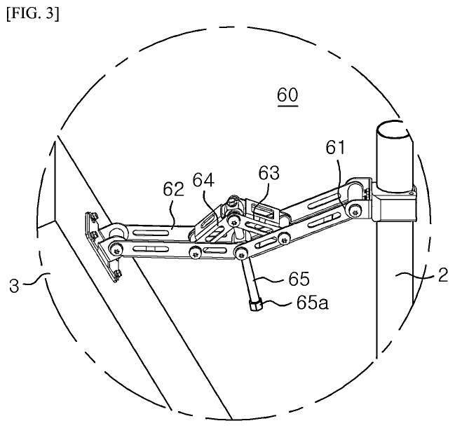

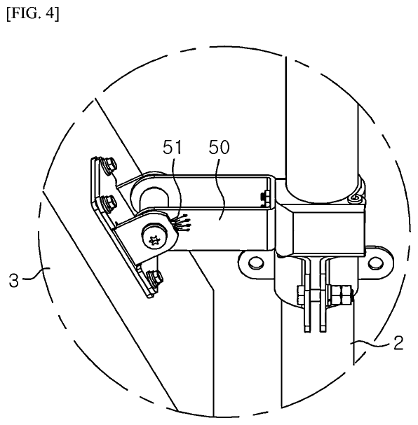

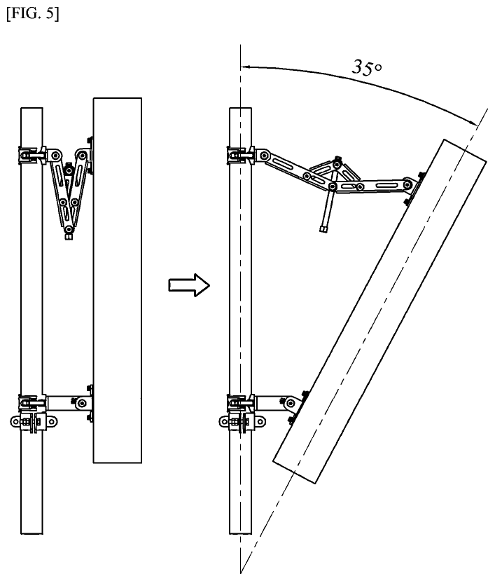

FIG. 2 is a perspective view illustrating an antenna holding device according to one embodiment of the present invention, FIG. 3 is an enlarged view illustrating portion A of FIG. 2, and FIG. 4 is an enlarged view illustrating portion B of FIG. 2. Meanwhile, FIG. 5 is a view illustrating operations of the antenna holding device according to one embodiment of the present invention.

A configuration and operations of the antenna holding device according to the present invention will be described with reference to FIGS. 2 to 5.

An antenna holding device 1 according to the present invention includes an upper body clamp 10, a lower body clamp 20, an upper antenna bracket 30, a lower antenna bracket 40, a lower support bracket 50, and an angle adjusting member 60.

The upper body clamp 10 and the lower body clamp 20 are coupled to a pillar or the like to fix an antenna 3. Bolts 11 and 21 capable of fastening or unfastening the body clamps 10 and 20 may be provided on the upper body clamp 10 and the lower body clamp 20, and vertical installation positions of the upper body clamp 10 and the lower body clamp 20 on the pillar 2 may be freely adjusted.

The upper antenna bracket 30 is coupled to an upper portion of a rear surface of the antenna 3, and the lower antenna bracket 40 is coupled to a lower portion of the rear surface of the antenna. The upper antenna bracket 30 may be manufactured of stainless steel (SUS) or the like. In this case, corrosion resistance is strengthened.

One side of the lower support bracket 50 is connected to the lower body clamp 20, and the other side is connected to the lower antenna bracket 40, wherein at least one side is coupled using a hinge. In FIG. 4, it is illustrated that the lower support bracket 50 is hinge-coupled to the lower antenna bracket 40. The lower support bracket 50 may be a bracket having a “⊂” shape.

The angle adjusting member 60 includes a first fixing link 61 having one side hinge-coupled to the upper body clamp 10 and a second fixing link 62 having one side hinge-coupled to the upper antenna bracket 30, which are provided as a pair, and a first adjusting link 63 having one side coupled to the first fixing link 61 and a second adjusting link 64 having one side coupled to the second fixing link 62, which are provided as a pair. The first fixing link 61 and the second fixing link 62 are hinge-coupled to each other, and the first adjusting link 63 and the second adjusting link 64 are hinge-coupled to each other.

One side of the angle adjusting member 60 formed as described above is coupled to the upper body clamp 10, and the other side is coupled to the upper antenna bracket 30.

In the antenna holding device 1 formed as described above, the angle adjusting member 60 may be folded or unfolded to easily adjust an orientation angle of the antenna 3 and firmly and stably maintain an adjusted inclination angle. Meanwhile, an angle of the antenna 3 may be adjusted to 35° clockwise in a front view.

Meanwhile, an angle adjustment rod 65, which passes through and is coupled to a hinge-coupling portion between the first fixing link 61 and the second fixing link 62, and a hinge-coupling portion between the first adjusting link 63 and the second adjusting link 64, may be further included, and a screw thread (not shown) is formed on an outer circumferential surface of the angle adjustment rod 65 so that an angle of the angle adjusting member 60 may be adjusted by rotation or counter-rotation of the angle adjustment rod 65. That is, as the angle adjustment rod 65 is rotated clockwise or counterclockwise, the antenna faces forward or downward.

In addition, a rotary nut 65a may be provided on one end of the angle adjustment rod 65. When the rotary nut 65a is provided on one end of the angle adjustment rod 65, the angle adjustment rod 65 may be easily rotated using the rotary nut 65a. In addition, an anti-loosening bolt may be provided on the other end of the angle adjustment rod 65.

In addition, a protractor 51 may be provided on one side surface of the lower support bracket 50. When the protractor 51 is provided on the one side surface of the lower support bracket 50, a rotation angle can be easily recognized because the rotation angle is displayed.

In addition, although not illustrated in the drawings, a through hole may be formed in one end of the angle adjustment rod 65 instead of the rotary nut 65a. In this case, an angle of the antenna 3 may be easily adjusted by inserting a rod into the corresponding through hole and rotating the rod to rotate the angle adjustment rod 65. In addition, the angle adjustment rod 65 may be formed in a “┐” shape in which a handle is formed on one end. In this case, since the handle may be held and the angle adjustment rod 65 may be rotated, the angle of the antenna can be more easily adjusted.

Although the present disclosure has been described with reference to embodiments illustrated in the accompanying drawings, the embodiments are only exemplary, and it will be understood by those skilled in the art that various modifications and other equivalent example embodiments may be made from the embodiments of the present disclosure. Therefore, the scope of the present disclosure should be defined by the appended claims.

1. An antenna holding device comprising:
an upper body clamp coupled to a pillar or the like to fix an antenna;
a lower body clamp disposed below the upper body clamp and coupled to the pillar or the like;
an upper antenna bracket coupled to an upper portion of a rear surface of the antenna;
a lower antenna bracket coupled at a lower side of the upper antenna bracket;
a lower support bracket of which one side is connected to the lower body clamp and the other side is connected to the lower antenna bracket, wherein at least any one side is coupled using a hinge; and
an angle adjusting member of which one side is hinge-coupled to the upper body clamp and the other side is hinge-coupled to the upper antenna bracket,
wherein the angle adjusting member includes a first fixing link of which one side is hinge-coupled to the upper body clamp and a second fixing link of which one side is hinge-coupled to the upper antenna bracket, which are provided as a pair, and
a first adjusting link of which one side is hinge-coupled to the first fixing link and a second adjusting link of which one side is hinge-coupled to the second fixing link, which are provided as a pair,
the first fixing link and the second fixing link are hinge-coupled to each other, and
the first adjusting link and the second adjusting link are hinge-coupled to each other.

2. The antenna holding device of claim 1, further comprising an angle adjustment rod which passes through and is coupled to a hinge-coupling portion between the first fixing link and the second fixing link and a hinge-coupling portion between the first adjusting link and the second adjusting link,
wherein a screw thread is formed on an outer circumferential surface of the angle adjustment rod such that an angle of the angle adjusting member is adjusted through rotation or counter-rotation of the angle adjustment rod.

3. The antenna holding device of claim 1, wherein a rotary nut is provided on one end of the angle adjustment rod.

4. The antenna holding device of claim 1, wherein a protractor is attached to one side surface of the lower support bracket.
